(19) United States
(12) Patent Application Publication
(10) Pub. No.: US 2019/0254077 A1
(43) Pub. Date: Aug. 15, 2019

(54) METHODS, DEVICES AND NETWORK NODES FOR PERFORMING AN ACCESS PROCEDURE

(71) Applicant: TELEFONAKTIEBOLAGET LM ERICSSON (PUBL), Stockholm (SE)

(72) Inventors: Henrik SAHLIN, MÖLNLYCKE (SE); Andres REIAL, MALMÖ (SE); Asbjörn GRÖVLEN, STOCKHOLM (SE); Johan AXNÄS, SOLNA (SE)

(21) Appl. No.: 16/346,063

(22) PCT Filed: Nov. 3, 2017
(86) PCT No.: PCT/IB2017/056893

§ 371 Date: Apr. 29, 2019

Related U.S. Application Data
(60) Provisional application No. 62/417,541, filed on Nov. 4, 2016.

(51) Int. Cl. H04W 74/08; H04W 56/00; H04W 72/04

(52) U.S. Cl. CPC H04W 74/0833; H04W 72/044; H04W 56/001

(57) ABSTRACT

A method in a wireless device for performing an access procedure comprises: receiving an indication from a network node, the indication comprising an allocation of a plurality of Physical Random Access Channel (PRACH) resources for PRACH preamble transmission, wherein the plurality of PRACH resources comprises one of a first combination and a second combination of time resources, frequency resources and sequences, wherein the first combination comprises a plurality of time resources, one or more frequency resources and a first plurality of sequences and the second combination comprises one or more time resources, a plurality of frequency resources and a second plurality of sequences; and selecting a PRACH resource among the plurality of PRACH resources. A wireless device for performing this method is also disclosed.

### RELATED APPLICATIONS

The present application claims the benefits of priority of U.S. Provisional Patent Application No. 62/417,541, entitled “Methods and Radio Nodes for performing an access procedure in a communication network” filed at the United States Patent and Trademark Office on Nov. 4, 2016, the content of which is incorporated herein by reference.

### TECHNICAL FIELD

The present disclosure relates to methods and radio nodes for performing an access procedure in a communication network.

### BACKGROUND

A random-access (RA) procedure is an important function in a cellular communication network. It allows the network to know that a User Equipment (UE) desires to connect to the network and it allows the UE to get access to the network. The RA procedure is also used for transitioning from an idle mode to an active mode, and for handovers.

In a LongTerm Evolution (LTE) network, a UE that would like to access the network initiates the random-access procedure, which is part of an initial access procedure 100 as illustrated in FIG. 1.

Before a UE can communicate with a base station, such as an eNodeB (eNB), the UE needs to be synchronized with the network. To do so, the UE goes through an initial synchronization process, where the UE receives one or several Synchronization Signals (SS) at step 110, e.g. Primary SS (PSS), Secondary SS (SSS), New Radio (NR) PSS (NR-PSS), NR-SSS, etc., from an eNB or gNB.

In step 120, the eNB sends configuration parameters on a broadcast channel, such as the Physical Broadcast Channel (PBCH) or NR-PBCH. For example, the configuration parameters are given in a Master Information Block (MIB).

Once synchronized, the UE can read the MIB to know/get the configuration parameters. Then, in step 130, the UE transmits a preamble, in Message 1 (Msg1), in the uplink on the Physical Random-Access Channel (PRACH) to the eNB. The eNB will receive the preamble and detect the random-access attempt from the UE. Then, the eNB will respond in the downlink by transmitting a Random-Access Response (RAR), in Message 2 (Msg2), to the UE, in step 140. The RAR carries an uplink scheduling grant for the UE to continue the procedure by transmitting a following subsequent message in the uplink (Message 3 (Msg3)) for terminal/UE identification (step 150). Also, the UE can send a Radio Resource Connection (RRC) request in Msg3 to the eNB (step 150).

In step 160, the eNB responds to Msg3 by sending downlink control information on the Physical Downlink Control Channel (PDCCH). Furthermore, in step 170, the eNB responds with a contention resolution message in Message 4 (Msg 4) on the Physical Downlink Shared Channel (PDSCH).

A similar procedure as the one illustrated in FIG. 1 is envisioned for New Radio (NR). As such, the eNB is replaced by a gNB or TRP (Transmission and Reception Point, i.e. a base station, access node).

A possible design for NR PRACH preambles is described in [R1-1609671, “NR PRACH preamble design”, 3GPP TSG-RAN WG1 #86bis, Lisbon, Portugal, Sep. 10-14, 2016], and is illustrated in FIG. 2.

FIG. 2 illustrates a PRACH preamble format with preambles constructed by repeating OFDM symbols. More specifically, one OFDM symbol is repeated several times such that each OFDM symbol acts as a cyclic prefix for the next OFDM symbol. However, the OFDM symbols which are repeated have much smaller length as compared to LTE PRACH, and equal the same length as adjacent user data OFDM symbols. The number of available preamble sequences is reduced when reducing the length of the OFDM symbol.

A PRACH resource is defined which is common for several SS (NR-PSS and NR-SSS) as described in [R1-1609670, “NR random access procedure”, 3GPP TSG-RAN WG1 #86bis, Lisbon, Portugal, Sep. 10-14, 2016]. In other words, several SS transmissions, e.g. SS beams or time instances, can map to the same PRACH resource. FIG. 3 illustrates the relation between synchronization signals (SS), MIB and PRACH resources, with dynamic timing between SS and PRACH. This flexible timing indication of the PRACH resource has lower resource overhead compared to using a fixed timing. The timing from SS to the PRACH resource can be indicated in the MIB. Alternatively, this timing is conceivable in the SS itself or another related field, if another system information format should be agreed. Different SS can then be used for different timings such that the detected sequence within the SS gives the PRACH resource. This PRACH configuration might be specified as a timing relative to the SS and PBCH, and can be given as a combination of the payload in the MIB and another broadcasted system information.

A time indication that indicates to the UE when to listen for additional information and/or send the uplink signal is also described in PCT/SE2015/051183 “Beam-scan time indicator” by Dennis Hui, Kumar Balachandran, Johan Axnäs, Henrik Sahlin, Johan Rune, Icaro Leonardo Da Silva, Andres Reial, which was filed in 2015 Oct. 28.

The value of the time indicator may also be embedded in an uplink response (e.g. PRACH preamble or system access request) from the UE. This may be useful to help the network determine which downlink beam the UE measured as the best beam. Related documents on selecting PRACH sequence based on best Downlink (DL) beam includes WO2015/147717 “System and method for beam-based physical random-access” by Mattias Frenne, Håkan Andersson Y, Johan Furuskog, Stefan Parkvall, Henrik Sahlin, Qiang Zhang, which was filed 2014 Aug. 29.

The systems described above may still need improvements, especially regarding the system related to FIG. 2, where the number of available preamble sequences is reduced when reducing the length of the OFDM symbol

### SUMMARY

According to a first aspect of the invention, there is provided a method in a network node for performing an access procedure. The method comprises: sending an indication of an allocation of a plurality of Physical Random Access Channel (PRACH) resources to a wireless device, wherein the plurality of PRACH resources comprises one of a first combination and a second combination of time resources, frequency resources and sequences, wherein the first combination comprises a plurality of time resources, one or more frequency resources and a first plurality of sequences and the second combination comprises one or more time resources, a plurality of frequency resources and a second plurality of sequences; and receiving a PRACH preamble from the wireless device during a time resource selected from one of the plurality of time resources and the one or more time resources, and on a frequency resource selected from one of the one or more frequency resources and the plurality of frequencies, the PRACH preamble comprising a sequence selected from one of the first plurality of sequences and the second plurality of sequences.

According to a second aspect, there is provided a network node to perform the method according to the first aspect. The network node comprises a processing circuitry and a memory connected thereto, wherein the memory comprises instructions that, when executed, cause the processing circuitry to perform the method according to the first aspect.

According to a third aspect, there is provided method in a wireless device for performing an access procedure. The method comprises: receiving an indication from a network node, the indication comprising an allocation of a plurality of Physical Random Access Channel (PRACH) resources for PRACH preamble transmission, wherein the plurality of PRACH resources comprises one of a first combination and a second combination of time resources, frequency resources and sequences, wherein the first combination comprises a plurality of time resources, one or more frequency resources and a first plurality of sequences and the second combination comprises one or more time resources, a plurality of frequency resources and a second plurality of sequences; selecting a PRACH resource among the plurality of PRACH resources, wherein the selected PRACH resource is associated with a time resource selected from one of the plurality of time resources and the one or more time resources, a frequency resource selected from one of the one or more frequency resources and the plurality of frequency resources and a sequence selected from one of the first plurality of sequences and the second plurality of sequences; and during the selected time resource, transmitting a PRACH preamble comprising the selected sequence on the selected frequency resource, to the network node.

According to a fourth aspect, there is provided a wireless device for performing the method according to the third aspect. The wireless device comprises a processing circuitry and a memory connected thereto, wherein the memory comprises instructions that, when executed, cause the processing circuitry to perform that the method according to the third aspect.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a schematic diagram of the initial access procedure in a communication network.

FIG. 2 is an illustration of a PRACH preamble format with preambles constructed by repeating OFDM symbols.

FIG. 3 is an illustration of the relation between synchronization signals (SS), MIB and PRACH resources, with dynamic timing between SS and PRACH.

FIG. 4 is a schematic diagram of a communication network.

FIG. 5 is an illustration of the relation between synchronization signals (SS), MIB and PRACH resources, with several timing and frequency PRACH resources in PBCH.

FIG. 6 is an illustration of the relation between synchronization signals (SS), MIB and PRACH resources in two gNBs.

FIG. 7 is a flowchart of a method in a second radio node, according to an embodiment.

FIG. 8 is a flowchart of a method in first radio node, according to an embodiment.

FIG. 9 is a schematic illustration of a wireless device (or second radio node) according to an embodiment.

FIG. 10 is a schematic illustration of a network node (or first radio node) according to an embodiment.

FIG. 11 is a schematic illustration of a second radio node, according to another embodiment.

FIG. 12 is a schematic illustration of a first radio node, according to another embodiment.

FIG. 13 is a flow chart of a method in a wireless device.

FIG. 14 is a flow chart of a method in a network node.

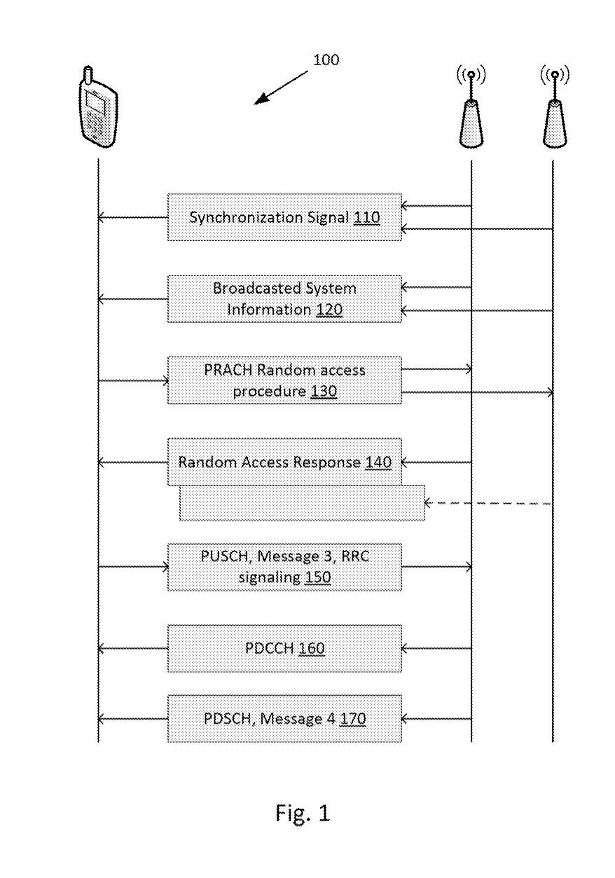

### DETAILED DESCRIPTION

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

Many aspects will be described in terms of sequences of actions or functions. It should be recognized that in some embodiments, some functions or actions could be performed by specialized circuits, by program instructions being executed by one or more processors, or by a combination of both.

Further, some embodiments can be partially or completely embodied in the form of computer readable carrier or carrier wave containing an appropriate set of computer instructions that would cause a processor to carry out the techniques described herein.

In some alternate embodiments, the functions/actions may occur out of the order noted in the sequence of actions. Furthermore, in some illustrations, some blocks, functions or actions may be optional and may or may not be executed; these are generally illustrated with dashed lines.

Generally, all terms used herein are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

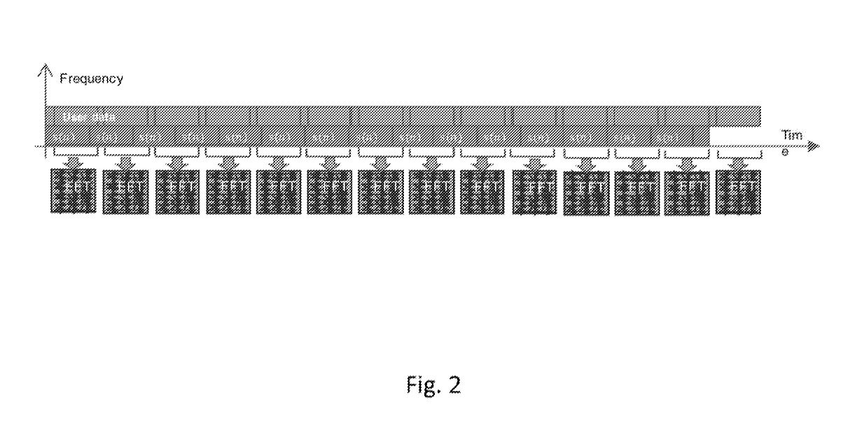

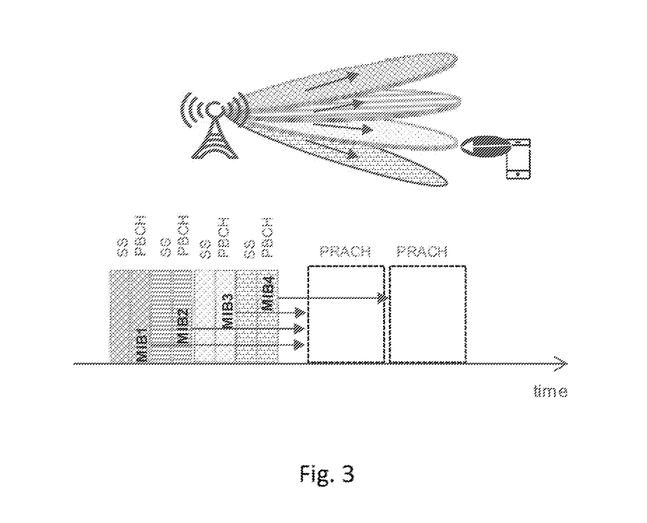

Using the short-symbol preamble technique as described above (e.g. FIG. 2), the number of uniquely defined PRACH preamble sequences might be too small for avoiding collisions between preambles transmitted from different UEs. The addressable space may be extended by reserving multiple PRACH timings, whereby the PRACH preamble is defined by the combination of the sequence and the timing. However, this is expensive in terms of resource usage and incurs PRACH latency that may be unacceptable.

There is thus a need for a PRACH preamble definition framework that allows for defining a larger set of unique preambles without the above negative effects. Certain aspects and their embodiments of the present disclosure may provide solutions to these or other problems.

Generally stated, embodiments of this disclosure allow to allocate several resources in time, frequency and code domain. The allocation of resources is conveyed to the UE by the gNB. In one embodiment, the UE can select between several of these resources.

Before describing the embodiments, an exemplary communication network will be described, in which the embodiments can be implemented.

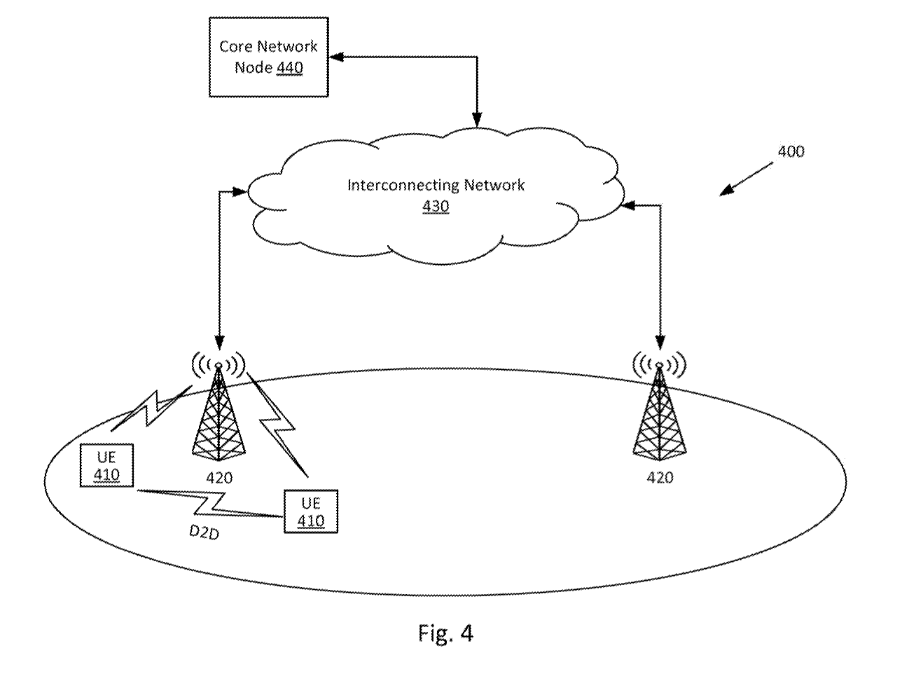

FIG. 4 illustrates an example of a wireless network or communication network 400 that may be used for wireless communications. Wireless network 400 includes wireless devices 410 (e.g., user equipments, UEs) and a plurality of radio access nodes or network nodes 420 (e.g., eNBs, gNBs, etc.) connected to one or more core network nodes 440 via an interconnecting network 430. The network 400 may use any suitable deployment scenarios, such as a non-centralized, co-sited, centralized, or shared deployment scenario. Wireless devices 410 within a coverage area may each be capable of communicating directly with radio access nodes 420 over a wireless interface. In certain embodiments, wireless devices 410 may also be capable of communicating with each other via device-to-device (D2D) communication. In certain embodiments, radio access nodes 420 may also be capable of communicating with each other, e.g. via an interface (e.g. X2 in LTE or other suitable interface).

As an example, wireless device 410 may communicate with radio access node 420 over a wireless interface. That is, wireless device 410 may transmit wireless signals and/or receive wireless signals from radio access node 420. The wireless signals may contain voice traffic, data traffic, control signals, and/or any other suitable information. In some embodiments, an area of wireless signal coverage associated with a radio access node 420 may be referred to as a cell.

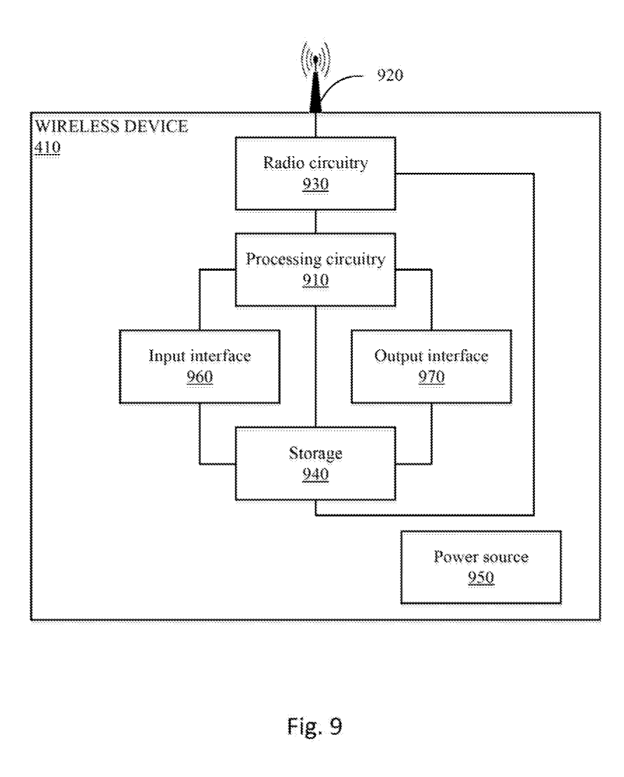

In some embodiments, wireless device 410 may be interchangeably referred to by the non-limiting term user equipment (UE). Wireless device 410 can be any type of wireless device capable of communicating with network node or another UE over radio signals. The UE may also be radio communication device, target device, device to device (D2D) UE, machine type UE or UE capable of machine to machine communication (M2M), a sensor equipped with UE, iPAD, Tablet, mobile terminals, smart phone, laptop embedded equipped (LEE), laptop mounted equipment (LME), USB dongles, Customer Premises Equipment (CPE), etc. Example embodiments of a wireless device 410 are described in more detail below with respect to FIG. 9.

In some embodiments, generic terminology “network node” is used. A “network node” refers to equipment capable, configured, arranged and/or operable to communicate directly or indirectly with a wireless device and/or with other equipment in the wireless communication network that enable and/or provide wireless access to the wireless device. As such, it can be any kind of network node which may comprise a radio network node such as radio access node 420 (which can include a base station, radio base station, base transceiver station, base station controller, network controller, gNB, NR BS, evolved Node B (eNB), Node B, Multi-cell/multicast Coordination Entity (MCE), relay node, access point, radio access point, Remote Radio Unit (RRU), Remote Radio Head (RRH), a multi-standard BS (also known as MSR BS), etc.), a core network node (e.g., MME, SON node, a coordinating node, positioning node, MDT node, etc.), or even an external node (e.g., 3rd party node, a node external to the current network), etc. The network node may also comprise a test equipment.

The term “radio network node” used herein can be any kind of network node comprised in a radio network which may further comprise any of base station (BS), radio base station, base transceiver station (BTS), base station controller (BSC), radio network controller (RNC), evolved Node B (eNB or eNodeB), Node B, multi-standard radio (MSR) radio node such as MSR BS, relay node, donor node controlling relay, radio access point (AP), transmission points, transmission nodes, Remote Radio Unit (RRU) Remote Radio Head (RRH), nodes in distributed antenna system (DAS) etc.

The term radio access technology (RAT) may refer to any RAT e.g. UTRA, E-UTRA, narrow band internet of things (NB-IoT), WiFi, Bluetooth, next generation RAT (NR), 4G, 5G, etc. Any of the first and the second nodes may be capable of supporting a single or multiple RATs.

The term “radio node” may be used to denote a UE (e.g., wireless device 410) or a radio network node (e.g., radio access node 420). A radio node may also be in some cases interchangeably called a transmission point (TP) or transmission reception point (TRP).

The embodiments are applicable to single carrier as well as to multicarrier or carrier aggregation (CA) operation of the UE in which the UE is able to receive and/or transmit data to more than one serving cells. The term carrier aggregation (CA) is also called (e.g. interchangeably called) “multi-carrier system”, “multi-cell operation”, “multi-carrier operation”, “multi-carrier” transmission and/or reception. In CA one of the component carriers (CCs) is the primary component carrier (PCC) or simply primary carrier or even anchor carrier. The remaining ones are called secondary component carrier (SCC) or simply secondary carriers or even supplementary carriers. The serving cell is interchangeably called as primary cell (PCell) or primary serving cell (PSC). Similarly, the secondary serving cell is interchangeably called as secondary cell (SCell) or secondary serving cell (SSC).

The term “signaling” used herein may comprise any of: high-layer signaling (e.g., via RRC or the like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “radio signal” may also be interchangeably used with the term radio channel and may comprise physical or logical channel. Example signals/channels: reference signal, synchronization signal, broadcast channel, paging channel, control channel, data cannel, shared channel, etc.

The term “time resource” used herein may correspond to any type of physical resource or radio resource expressed in terms of length of time. Examples of time resources are: symbol, time slot, subframe, radio frame, TTI, interleaving time, etc.

In certain embodiments, radio access nodes 420 may interface with a radio network controller. The radio network controller may control radio access nodes 420 and may provide certain radio resource management functions, mobility management functions, and/or other suitable functions. In certain embodiments, the functions of the radio network controller may be included in radio access node 420. The radio network controller may interface with a core network node 440. In certain embodiments, the radio network controller may interface with the core network node 440 via an interconnecting network 430.

The interconnecting network 430 may refer to any interconnecting system capable of transmitting audio, video, signals, data, messages, or any combination of the preceding. The interconnecting network 430 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the core network node 440 may manage the establishment of communication sessions and various other functionalities for wireless devices 410. Examples of core network node 440 may include MSC, MME, SGW, PGW, O&M, OSS, SON, positioning node (e.g. E-SMLC), MDT node, etc. Wireless devices 410 may exchange certain signals with the core network node using the non-access stratum layer. In non-access stratum signaling, signals between wireless devices 410 and the core network node 440 may be transparently passed through the radio access network. In certain embodiments, radio access nodes 420 may interface with one or more network nodes over an internode interface. For example, radio access nodes 420 may interface over an X2 interface with each other.

Although FIG. 4 illustrates a particular arrangement of network 400, the present disclosure contemplates that the various embodiments described herein may be applied to a variety of networks having any suitable configuration. For example, network 400 may include any suitable number of wireless devices 410 and radio access nodes 420, as well as any additional elements suitable to support communication between wireless devices or between a wireless device and another communication device (such as a landline telephone). The embodiments may be implemented in any appropriate type of telecommunication system supporting any suitable communication standards and using any suitable components, and are applicable to any radio access technology (RAT) or multi-RAT systems in which the wireless device receives and/or transmits signals (e.g., data). While certain embodiments are described for NR and/or LTE, the embodiments are applicable to any RAT, such as UTRA, E-UTRA, narrow band internet of things (NB-IoT), WiFi, Bluetooth, next generation RAT (NR, NX), 4G, 5G, LTE FDD/TDD, WCDMA/HSPA, GSM/GERAN, WLAN, CDMA2000, etc.

As mentioned above, in order for a UE 410 to connect or access the network 400, it needs to perform the Random access procedure, using a PRACH preamble. In the context of the short-symbol preamble design, and in order to avoid collisions between different UEs sending preambles, there is a need to design PRACH preambles that allow to define a larger set of unique preambles. To do so, a network node allocates PRACH resources, where each resource comprises a combination of time, frequency and code domain (or sequence), for example.

It should be noted that the terms “code domain”, “resources for codes” and “sequences” designate the same thing, as such, these terms can be used interchangeably.

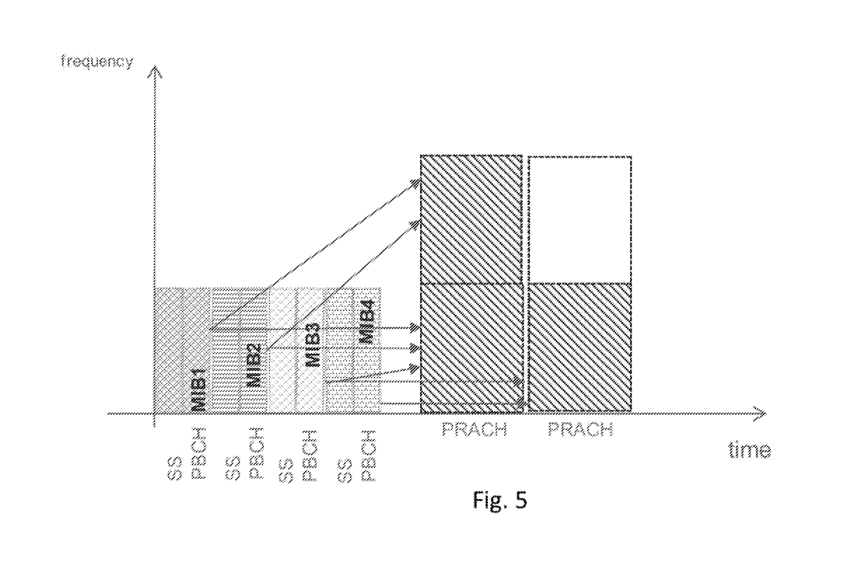

An illustration of PRACH resources configured in PBCH according to an embodiment is given in FIG. 5. FIG. 5 shows a relation between the synchronization signals (SS), MIB and PRACH resources, with several timing and frequency PRACH resources in each PBCH. Also, several SS and PBCH transmissions are illustrated in FIG. 5. Preferably these are transmitted in different beams from the gNB. Each PBCH contains a MIB, where these MIBs are numbered as MIB1, MIB2, etc.

In the example of FIG. 5, the MIB1 configures two PRACH resources in different frequency intervals but at the same time. The set of sequences which the UE can select from might be the same or different between these two frequency intervals. A second PBCH contains a MIB 2 which might be indicating the same time and frequency resources as MIB1, but a different set of sequences. A third PBCH contains MIB3 which configures two PRACH resources. The first PRACH resource configured in MIB3 is reusing one time and frequency resource with MIB 2, with either a different sequence or the same sequence. The second PRACH resource configured in MIB3 is configured in another time interval as compared to the first PRACH resource. A fourth PBCH contains a MIB4 which only has one time and frequency resource.

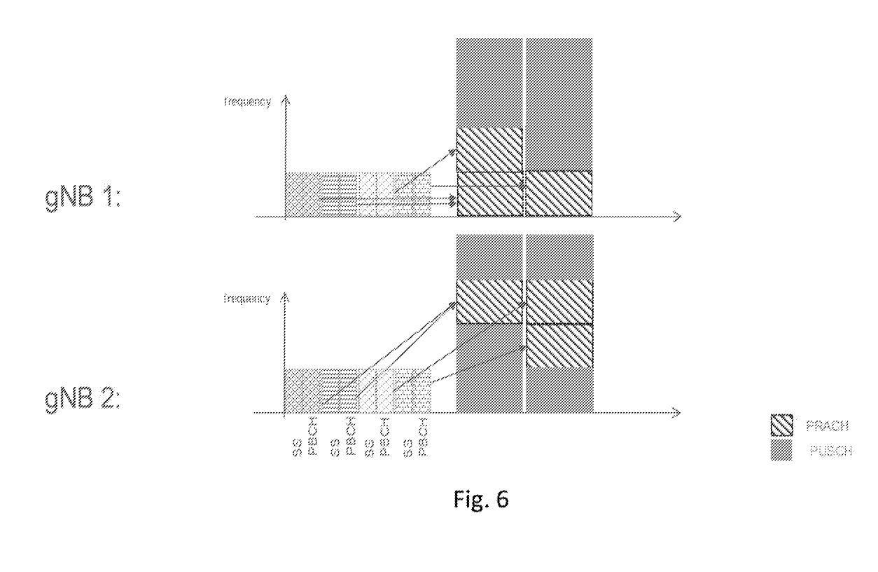

It should be noted that time and frequency resources are not allocated to PRACH in the cell which is represented by the rectangle (not hashed) at the top right of FIG. 5. The resources in this cell can be used for data transmissions or for PRACH in other cells (e.g. FIG. 6).

A PRACH preamble index is proposed to be identified by a combination of the following parameters:
Sequence:
   e.g. root sequence between 1 to 70 for a Zadoff-Chu sequence with 71 sub-carriers; and
   e.g. cyclic shifts of the root sequence; this cyclic shift should be larger than maximum RTT (Round Trip Time) in the cell where the gNB is active.
Frequency resource: Subband index describing the subband location of the PRACH signal
   e.g. 0 to 7.
Subframe: Timing offsets indicating a future subframe for PRACH preamble:
   e.g. with 2 different possible sub-frames.

With the above examples, the total number of PRACH preambles=71*8*2=1132. This is significantly larger than the 838 PRACH root sequences in LTE.

An illustration of PRACH configurations of two gNBs according to an embodiment is given in FIG. 6. FIG. 6 shows the relation between synchronization signals (SS), MIB and PRACH resources in two gNBs, e.g. gNB1 and gNB2. The two gNBs are using non-overlapping time/frequency resources. In other words, the two gNBs do not configure the same time and frequency resources for PRACH, as can be seen in FIG. 6. The resources not used for PRACH might be used for other uplink transmissions (PUSCH) to the given gNB. In other words, at each gNB, only the resources used by that gNB need to be excluded from other UpLink (UL) transmissions. If the two gNBs are close, then the PUSCH transmissions from one UE close to one gNB will introduce interference in the reception of PRACH preambles in the other gNB. However, it will most likely not generate a PRACH detection since the PUSCH has low correlation with PRACH preambles.

It should be noted that SS and PBCH may be collectively referred to as SS block. SS are the synchronization sequences and PBCH contains the system information. As such, the PBCH contains information allowing the UE to know what PRACH resources are available for it to use.

In some embodiments, the configuration of the PRACH resources are configured in a MIB in PBCH. Alternatively, the PRACH resources could be configured in a Remaining Minimum System Information (RMSI). To do so, the sequence, frequency resource and time resource can be specified as separate indicators. An example is given below, where 70 root sequences are available:
Preamble root subset: 3 bits: {0, . . . 69}, {0, . . . 34}, {35, . . . 69}, {0, . . . 16}, {17, . . . 33}, {35, . . . 51}, {52, . . . 69},
Cyclic shift: 2 bits: {0}, {half symbol}, {quarter of symbol}, {three quarter of symbol}
Frequency resource: 4 bits: {0}, {1}, . . . , {7}, {0,1}, {2,3}, . . . , {6,7}, {0,1,2}
Timing offsets: 3 bit: {0}, {1}, {0,1}.

It should be noted that a timing offset or time offset can refer to the delay between a received SS block and a PRACH transmission.

In other embodiments, a PRACH preamble configuration index is given in the MIB, which maps to a table containing one configuration of sequence, frequency resource and time resource for each index. See example below in Table 1:

TABLE 1
PRACH preamble configuration

| PRACH | | | | |
|---|---|---|---|---|
| preamble | Preamble | | | |
| configuration | root | Cyclic | Frequency | Timing |
| index | subset | shift | resource | offsets |
| 0 | {0, . . . 69} | 0 | 0 | 0 |
| 1 | {0, . . . 69} | 0 | 1 | 0 |
| 2 | {0, . . . 69} | 0 | 2 | 0 |
| . . . | | | | |
| N1 | {0, . . . 69} | 0 | 0 | 1 |
| N1 + 1 | {0, . . . 69} | 0 | 1 | 1 |
| . . . | | | | |
| N2 | {0, . . . 34} | 0 | {0, 1} | 0 |
| N2 + 1 | {35, . . . 69} | 0 | {0, 1} | 0 |
| N2 + 2 | {0, . . . 34} | 0 | 0 | {0, 1} |
| N2 + 3 | {35, . . . 69} | 0 | 0 | {0, 1} |
| N2 + 4 | {0, . . . 16} | 0 | {0, 1, 2, 3} | 0 |
| . . . | | | | |
| N3 | {0, . . . 16} | 0 | 0 | {0, 1, 2, 3} |
| . . . | | | | |
| N4 | {0, . . . 69} | 1 | 0 | 0 |
| . . . | | | | |

Within this table, some configurations indicate several time and frequency resources, with fewer base sequences in each resource as compared to allocations with one time and frequency resource. For example, several time resources are beneficial in unlicensed spectrum when the UE does an LBT (Listen Before Talk) before transmitting a PRACH preamble. If the LBT fails in one time allocation, then the UE can try another time allocation.

In yet another embodiment, the sets of allowed time/frequency/sequence combinations may be listed explicitly in the MIB.

Several frequency resources might be beneficial in scenarios where the channel or interference is varying over frequency. The UE might measure a frequency selective link budget, such that it can decide on a frequency resource in which the PRACH has a higher chance to succeed. Several frequency resources might also be beneficial for stationary, fixed wireless devices, in which different frequency intervals can be tried in different PRACH preamble attempts.

It should be noted that the configuration of PRACH resources may comprise a plurality of frequency resources and one or more time resources and a plurality of sequences. The configuration of PRACH resources may also comprises one or more frequency resources and a plurality of time resources and a plurality of sequences.

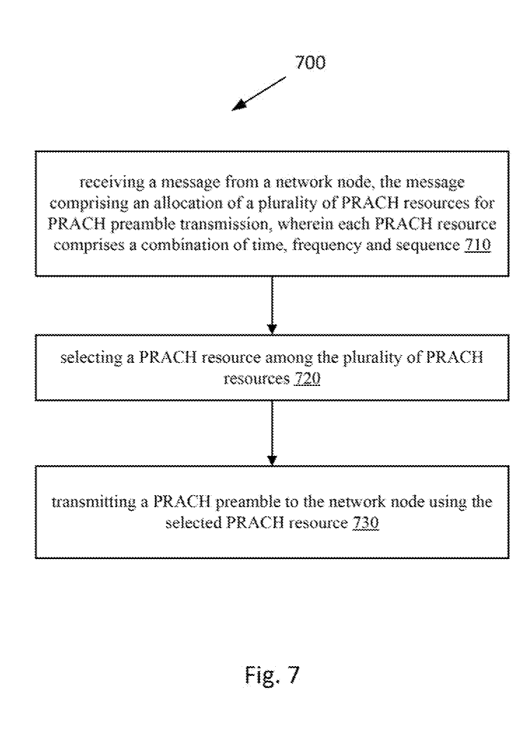

Now turning to FIG. 7, embodiments of a method in a wireless device, will be described. FIG. 7 illustrates a method 700 for performing an access procedure in a communication network by a wireless device. The communication network is for example the network 400. The wireless device can be the UE or wireless device 410.

Method 700 comprises receiving a message from a network node, the message comprising an allocation of a plurality of PRACH resources for PRACH preamble transmission, wherein each PRACH resource comprises a combination of time, frequency and sequence (block 710).

Method 700 comprises selecting a PRACH resource among the plurality of PRACH resources (block 720).

Method 700 comprises transmitting a PRACH preamble to the network node using the selected PRACH resource (block 730).

In some embodiments, the wireless device 410 receives a message comprising a MIB, in which the allocation of the plurality of PRACH resources is indicated. The indication can be done using separate indicators for the time, the frequency and the sequence. The indication can be done using the preamble index and the corresponding table 1. The indication can be done explicitly, wherein the plurality of combinations of time, frequency and sequence are listed explicitly in the MIB.

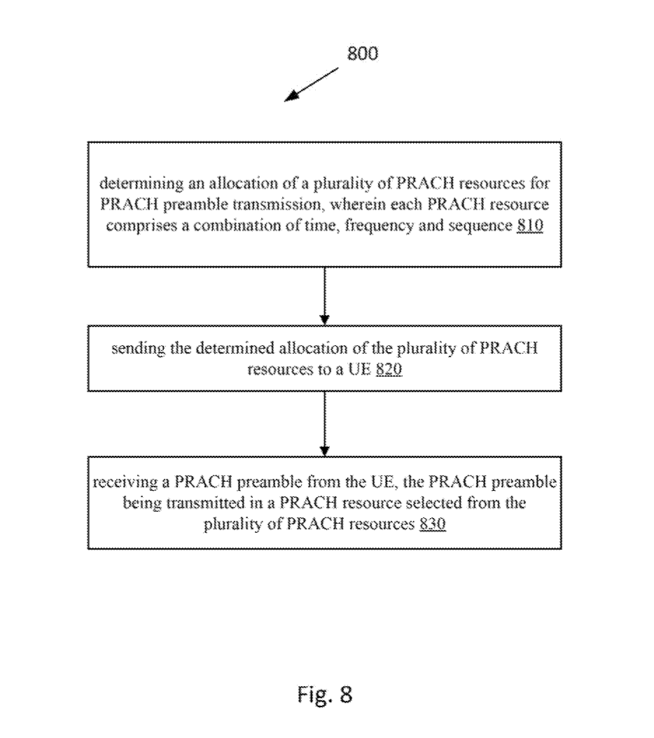

Now turning to FIG. 8, embodiments of a method 800 in a network node, will be described. FIG. 8 illustrates a method 800 for performing an access procedure in a communication network by a network node. The communication network is for example the network 400. The network node is for example the gNB or base station or radio access node 420.

Method 800 comprises determining an allocation of a plurality of PRACH resources for PRACH preamble transmission, wherein each PRACH resource comprises a combination of time, frequency and sequence (block 810).

Method 800 comprises sending the determined allocation of the plurality of PRACH resources to a wireless device (block 820).

Method 800 comprises receiving a PRACH preamble from the wireless device, the PRACH preamble being transmitted in a PRACH resource selected from the plurality of PRACH resources (block 830).

In some embodiments, determining an allocation of PRACH resources, in block 810, comprises, for example, configuring a plurality of PRACH resources using a combination of time, frequency and sequence. Furthermore, the gNB or radio access node 420 can specify several PRACH resource allocations in the same cell.

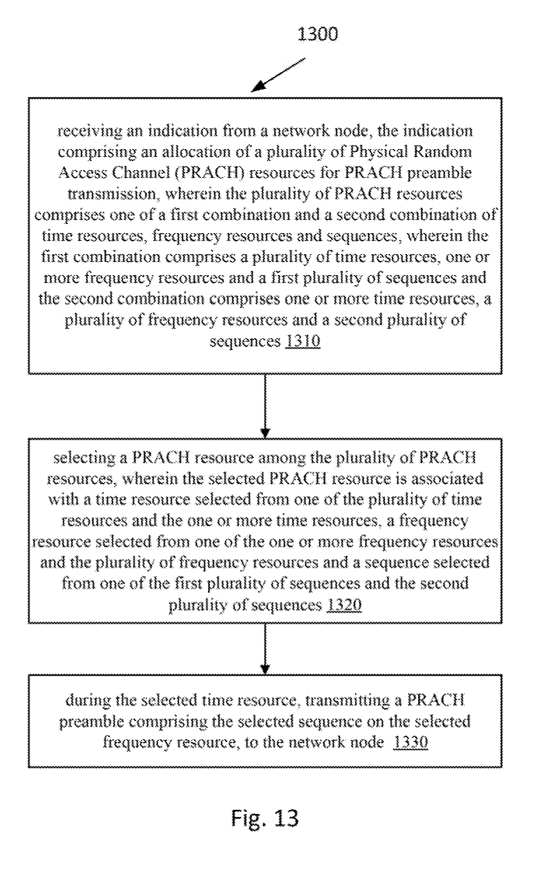

Now, turning to FIG. 13, a method 1300 for performing an access procedure in a communication network by a wireless device will be described. Method 1300 corresponds to method 700, in which some terms are better defined. The communication network is for example the network 400. The wireless device can be the UE or wireless device 410.

Method 1300 comprises receiving an indication from a network node (block 1310). The indication comprises an allocation of a plurality of Physical Random Access Channel (PRACH) resources for PRACH preamble transmission, wherein the plurality of PRACH resources comprises one of a first combination and a second combination of time resources, frequency resources and sequences, wherein the first combination comprises a plurality of time resources, one or more frequency resources and a first plurality of sequences and the second combination comprises one or more time resources, a plurality of frequency resources and a second plurality of sequences.

Method 1300 comprises selecting a PRACH resource among the plurality of PRACH resources (block 1320). The selected PRACH resource is associated with a time resource selected from one of the plurality of time resources and the one or more time resources, a frequency resource selected from one of the one or more frequency resources and the plurality of frequency resources and a sequence selected from one of the first plurality of sequences and the second plurality of sequences.

Method 1300 comprises during the selected time resource, transmitting a PRACH preamble comprising the selected sequence on the selected frequency resource, to the network node (block 1330).

In some embodiments, selecting the PRACH resource comprises selecting randomly a PRACH resource among the plurality of PRACH resources.

In some embodiments, selecting the PRACH resource comprises selecting a PRACH resource based on a specific criterion.

For example, the plurality of time resources from the first combination can comprise a time interval or a plurality of timing offsets from a synchronization signal.

For example, the one or more time resources from the second combination can comprise a time or a time interval or one or more timing offsets from a synchronization signal.

For example, the one or more frequency resources from the first combination can comprise a frequency or a frequency interval or one or more frequency subbands for indicating a location of a PRACH signal.

For example, the plurality of frequency resources from the second combination can comprise a frequency interval or a plurality of frequency subbands for indicating a location of a PRACH signal.

For example, the first and second pluralities of sequences can comprise a combination of a set of root sequences and a set of cyclic shifts.

In some embodiments, the allocation of the plurality of PRACH resources is carried by a Physical Broadcast CHAnnel (PBCH) associated with a synchronization signal. More specifically, the indication of the allocation of the plurality of PRACH resources is given by a Master Information Block (MIB) in the Physical Broadcast CHAnnel (PBCH).

In some embodiments, several synchronization signals and PBCH transmissions are transmitted in different beams from the network node.

In some embodiments, the MIB, when indicating the first combination, can comprise a first indicator for indicating the plurality of time resources, a second indicator for indicating the one or more frequency resources and a third indicator for indicating the plurality of sequences, the first, second and third indicators being separate indicators.

In some embodiments, the MIB, when indicating the first combination, comprises a PRACH preamble index for indicating a combination of time resources, frequency resources and sequences. For example, the PRACH preamble index is mapped to a table, the table having a list of indexes, each index corresponding to one configuration of a plurality of time resources, one or more frequency resources and a plurality of sequences.

In some embodiments, the MIB, when indicating the first combination, can list explicitly a set of allowed combinations of time resources, frequency resources and sequences.

In some embodiments, the MIB, when indicating the second combination, can comprise a first indicator for indicating the one or more time resources, a second indicator for indicating the plurality of frequency resources and a third indicator for indicating the plurality of sequences, the first, second and third indicators being separate indicators.

In some embodiments, the MIB, when indicating the second combination, can comprise a PRACH preamble index for indicating a combination of time resources, frequency resources and sequences. For example, the PRACH preamble index is mapped to a table, the table having a list of indexes, each index corresponding to one configuration of one or more time resources, a plurality of frequency resources and a plurality of sequences.

In some embodiments, the MIB, when indicating the second combination, can list explicitly a set of allowed combinations of time resources, frequency resources and sequences.

In some embodiments, method 1300 can comprise generating a PRACH preamble based on the selected sequence.

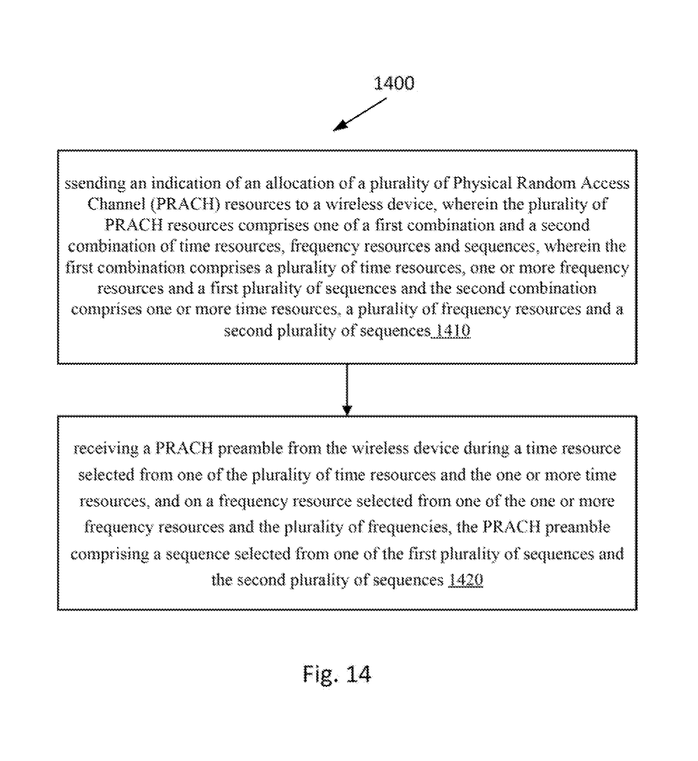

FIG. 14 illustrates a method 1400 for performing an access procedure in a communication network by a network node. Method 1400 corresponds to method 800, in which some terms are better defined and some steps are rearranged. The communication network is for example the network 400. The network node is for example the gNB or base station or radio access node 420.

Method 1400 comprises sending an indication of an allocation of a plurality of Physical Random Access Channel (PRACH) resources to a wireless device (block 1410). For example, the plurality of PRACH resources comprises one of a first combination and a second combination of time resources, frequency resources and sequences, wherein the first combination comprises a plurality of time resources, one or more frequency resources and a first plurality of sequences and the second combination comprises one or more time resources, a plurality of frequency resources and a second plurality of sequences.

Method 1400 comprises receiving a PRACH preamble from the wireless device during a time resource selected from one of the plurality of time resources and the one or more time resources, and on a frequency resource selected from one of the one or more frequency resources and the plurality of frequencies, the PRACH preamble comprising a sequence selected from one of the first plurality of sequences and the second plurality of sequences (block 1420).

In some embodiments, method 1400 further comprises determining the allocation of the plurality of PRACH resources, based on different factors and parameters, such as the quality of the channel.

For example, the plurality of time resources from the first combination can comprise a time interval or a plurality of timing offsets from a synchronization signal.

For example, the one or more time resources from the second combination can comprise a time or a time interval or one or more timing offsets from a synchronization signal.

For example, the one or more frequency resources from the first combination can comprise a frequency or a frequency interval or one or more frequency subbands for indicating a location of a PRACH signal.

For example, the plurality of frequency resources from the second combination can comprise a frequency interval or a plurality of frequency subbands for indicating a location of a PRACH signal.

For example, the first and second pluralities of sequences can comprise a combination of a set of root sequences and a set of cyclic shifts.

In some embodiments, the allocation of the plurality of PRACH resources is carried by a Physical Broadcast CHAnnel (PBCH) associated with a synchronization signal. More specifically, the indication of the allocation of the plurality of PRACH resources is given by a Master Information Block (MIB) in the Physical Broadcast CHAnnel (PBCH).

In some embodiments, several synchronization signals and PBCH transmissions are transmitted in different beams from the network node.

In some embodiments, the MIB, when indicating the first combination, can comprise a first indicator for indicating the plurality of time resources, a second indicator for indicating the one or more frequency resources and a third indicator for indicating the plurality of sequences, the first, second and third indicators being separate indicators.

In some embodiments, the MIB, when indicating the first combination, comprises a PRACH preamble index for indicating a combination of time resources, frequency resources and sequences. For example, the PRACH preamble index is mapped to a table, the table having a list of indexes, each index corresponding to one configuration of a plurality of time resources, one or more frequency resources and a plurality of sequences.

In some embodiments, the MIB, when indicating the first combination, can list explicitly a set of allowed combinations of time resources, frequency resources and sequences.

In some embodiments, the MIB, when indicating the second combination, can comprise a first indicator for indicating the one or more time resources, a second indicator for indicating the plurality of frequency resources and a third indicator for indicating the plurality of sequences, the first, second and third indicators being separate indicators.

In some embodiments, the MIB, when indicating the second combination, can comprise a PRACH preamble index for indicating a combination of time resources, frequency resources and sequences. For example, the PRACH preamble index is mapped to a table, the table having a list of indexes, each index corresponding to one configuration of one or more time resources, a plurality of frequency resources and a plurality of sequences.

In some embodiments, the MIB, when indicating the second combination, can list explicitly a set of allowed combinations of time resources, frequency resources and sequences.

FIG. 9 is a block diagram of an exemplary wireless device 410, in accordance with certain embodiments. The wireless device 410 may be a user equipment. Wireless device 410 includes processing circuitry 910, an antenna 920, radio front-end circuitry 930, and a computer-readable storage medium 940. Antenna 920 may include one or more antennas or antenna arrays, and is configured to send and/or receive wireless signals, and is connected to radio front-end circuitry 930. In certain alternative embodiments, wireless device 410 may not include antenna 920, and antenna 920 may instead be separate from wireless device 410 and be connectable to wireless device 410 through an interface or port.

The radio front-end circuitry 930 may comprise various filters and amplifiers, is connected to antenna 920 and processing circuitry 910, and is configured to condition signals communicated between antenna 920 and processing circuitry 910. In certain alternative embodiments, wireless device 410 may not include radio front-end circuitry 930, and processing circuitry 910 may instead be connected to antenna 920 without radio front-end circuitry 930.

Processing circuitry 910 may include any suitable combination of hardware and software implemented in one or more modules to execute instructions and manipulate data to perform some or all of the described functions of wireless device 410 (or second radio node), such as the functions of wireless device 410 described above. Processing circuitry 810 may include one or more of radio frequency (RF) transceiver circuitry, baseband processing circuitry, and application processing circuitry. The transceiver circuitry facilitates transmitting wireless signals to and receiving wireless signals from radio access node 420 (e.g., via an antenna 920). The transceiver circuitry may be connected to input interface 960 and output interface 970. In some embodiments, the RF transceiver circuitry, baseband processing circuitry, and application processing circuitry may be on separate chipsets. In alternative embodiments, part or all of the baseband processing circuitry and application processing circuitry may be combined into one chipset, and the RF transceiver circuitry may be on a separate chipset. In still alternative embodiments, part or all of the RF transceiver circuitry and baseband processing circuitry may be on the same chipset, and the application processing circuitry may be on a separate chipset. In yet other alternative embodiments, part or all of the RF transceiver circuitry, baseband processing circuitry, and application processing circuitry may be combined in the same chipset. Processing circuitry 810 may include, for example, one or more central processing units (CPUs), one or more processors or microprocessors, one or more application specific integrated circuits (ASICs), and/or one or more field programmable gate arrays (FPGAs). In certain embodiments, the one or more processors may comprise one or more of the modules discussed below with respect to FIG. 11.

In particular embodiments, some or all of the functionality described herein as being provided by a wireless device may be provided by the processing circuitry 910 executing instructions stored on a computer-readable storage medium/memory 940. For example, the processing circuitry 910 is configured to perform methods 700, 1300 and 1400 and all the embodiments related to these methods.

In alternative embodiments, some or all of the functionality may be provided by the processing circuitry 910 without executing instructions stored on a computer-readable medium, such as in a hard-wired manner. In any of those particular embodiments, whether executing instructions stored on a computer-readable storage medium or not, the processing circuitry can be said to be configured to perform the described functionality. The benefits provided by such functionality are not limited to the processing circuitry 910 alone or to other components of wireless device 410, but are enjoyed by the wireless device as a whole, and/or by end users and the wireless network generally.

Antenna 920, radio front-end circuitry 930, and/or processing circuitry 910 may be configured to perform any receiving operations described herein as being performed by a wireless device. Any information, data and/or signals may be received from a network node and/or another wireless device.

The processing circuitry 910 may be configured to perform any determining operations described herein as being performed by a wireless device. Determining as performed by processing circuitry 910 may include processing information obtained by the processing circuitry 910 by, for example, converting the obtained information into other information, comparing the obtained information or converted information to information stored in the wireless device, and/or performing one or more operations based on the obtained information or converted information, and as a result of said processing making a determination.

Antenna 920, radio front-end circuitry 930, and/or processing circuitry 910 may be configured to perform any transmitting operations described herein as being performed by a wireless device. Any information, data and/or signals may be transmitted to a network node and/or another wireless device.

Computer-readable storage medium 940 is generally operable to store instructions, such as a computer program, software, an application including one or more of logic, rules, code, tables, etc. and/or other instructions capable of being executed by a processor. Examples of computer-readable storage medium 840 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or any other volatile or non-volatile, non-transitory computer-readable and/or computer-executable memory devices that store information, data, and/or instructions that may be used by processing circuitry 910. In some embodiments, processing circuitry 910 and computer-readable storage medium 940 may be considered to be integrated.

Alternative embodiments of wireless device 410 may include additional components beyond those shown in FIG. 9 that may be responsible for providing certain aspects of the wireless device's functionality, including any of the functionality described herein and/or any functionality necessary to support the solution described above. As just one example, wireless device 410 may include input interfaces, devices and circuits, and output interfaces, devices and circuits, and one or more synchronization units or circuits, which may be part of the one or more processors. Input interfaces, devices, and circuits are configured to allow input of information into wireless device 410, and are connected to processing circuitry 910 to allow processing circuitry 910 to process the input information. For example, input interfaces, devices, and circuits may include a microphone, a proximity or other sensor, keys/buttons, a touch display, one or more cameras, a USB port, or other input elements. Output interfaces, devices, and circuits are configured to allow output of information from wireless device 410, and are connected to processing circuitry 910 to allow processing circuitry 910 to output information from wireless device 410. For example, output interfaces, devices, or circuits may include a speaker, a display, vibrating circuitry, a USB port, a headphone interface, or other output elements. Using one or more input and output interfaces, devices, and circuits, wireless device 410 may communicate with end users and/or the wireless network, and allow them to benefit from the functionality described herein.

As another example, wireless device 410 may include power source 950. Power source 950 may comprise power management circuitry. Power source 950 may receive power from a power supply, which may either be comprised in, or be external to, power source 950. For example, wireless device 410 may comprise a power supply in the form of a battery or battery pack which is connected to, or integrated in, power source 950. Other types of power sources, such as photovoltaic devices, may also be used. As a further example, wireless device 410 may be connectable to an external power supply (such as an electricity outlet) via an input circuitry or interface such as an electrical cable, whereby the external power supply supplies power to power source 950. Power source 950 may be connected to radio front-end circuitry 930, processing circuitry 910, and/or computer-readable storage medium 940 and be configured to supply wireless device 410, including processing circuitry 910, with power for performing the functionality described herein.

Wireless device 410 may also include multiple sets of processing circuitry 910, computer-readable storage medium 940, radio circuitry 930, and/or antenna 920 for different wireless technologies integrated into wireless device 410, such as, for example, GSM, WCDMA, LTE, NR, WiFi, or Bluetooth wireless technologies. These wireless technologies may be integrated into the same or different chipsets and other components within wireless device 410.

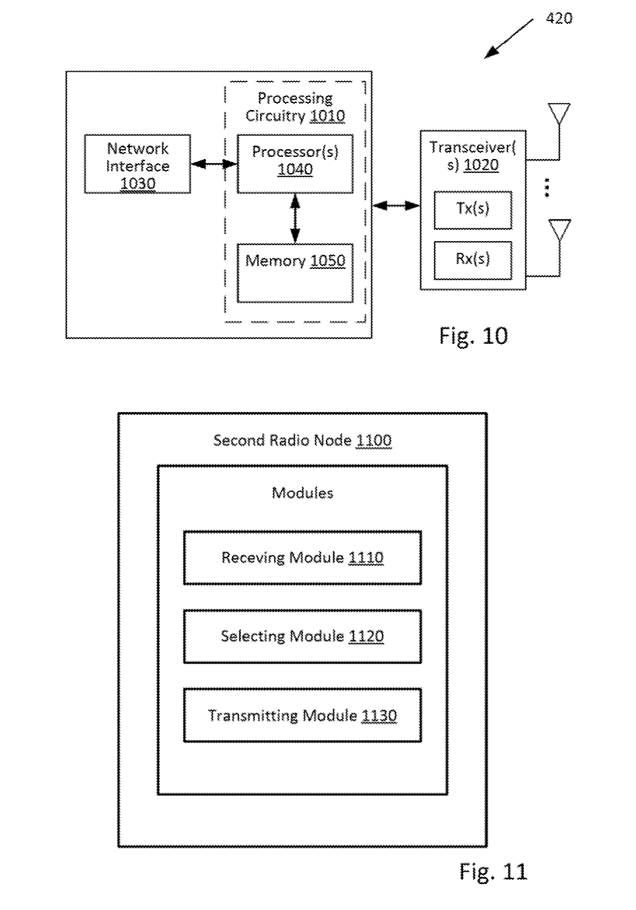

FIG. 10 is a block diagram of an exemplary radio access node or network node 420, which can be a base station or eNB or gNB for example, in accordance with certain embodiments. Radio access node 420 includes processing circuitry 1010, one or more of a transceiver 1020 and a network interface 1030. The circuitry 1010 may include one or more (node) processors 1040, and memory 1050. In some embodiments, the transceiver 1020 facilitates transmitting wireless signals to and receiving wireless signals from wireless device 410 (e.g., via an antenna), the one or more processors 1040 executes instructions to provide some or all of the functionalities described above as being provided by the radio access node 420, the memory 1050 stores the instructions for execution by the one or more processors 1040, and the network interface 1030 communicates signals to backend network components, such as a gateway, switch, router, Internet, Public Switched Telephone Network (PSTN), core network nodes or radio network controllers, etc.

The one or more processors 1040 may include any suitable combination of hardware and software implemented in one or more modules to execute instructions and manipulate data to perform some or all of the described functions of radio access node 420, such as those described above. For example, the processing circuitry 1010 (or the processors 1040) is configured to perform methods 800, 1500 and 1600 and all the embodiments related to those methods.

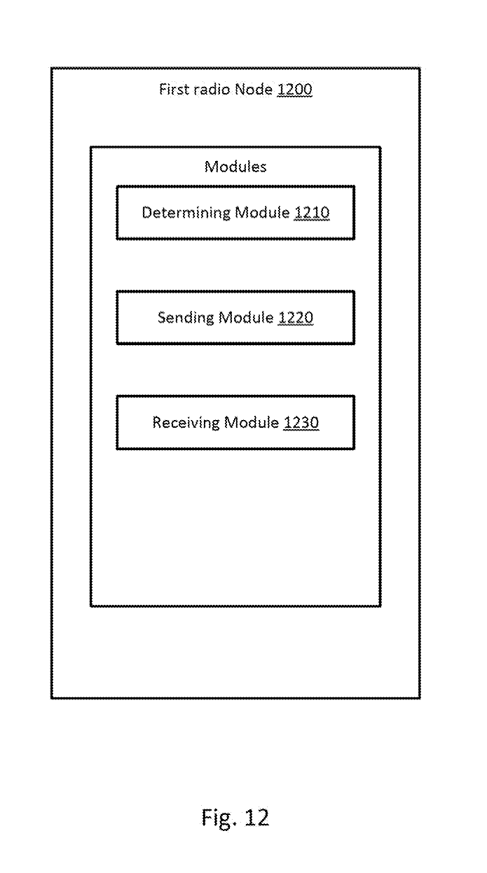

In some embodiments, the one or more processors 1040 may include, for example, one or more computers, one or more central processing units (CPUs), one or more microprocessors, one or more applications, one or more application specific integrated circuits (ASICs), one or more field programmable gate arrays (FPGAs) and/or other logic. In certain embodiments, the one or more processors 1040 may comprise one or more of the modules discussed below with respect to FIG. 12.

The memory 1050 is generally operable to store instructions, such as a computer program, software, an application including one or more of logic, rules, algorithms, code, tables, etc. and/or other instructions capable of being executed by one or more processors 940. Examples of memory 1050 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, the network interface 1030 is communicatively coupled to the one or more processors 1040 and may refer to any suitable device operable to receive input for the radio access node 420, send output from the radio access node 420, perform suitable processing of the input or output or both, communicate to other devices, or any combination of the preceding. The network interface 1030 may include appropriate hardware (e.g., port, modem, network interface card, etc.) and software, including protocol conversion and data processing capabilities, to communicate through a network.

Other embodiments of the radio access node 420 may include additional components beyond those shown in FIG. 10 that may be responsible for providing certain aspects of a radio network node's functionality, including any of the functionality described above and/or any additional functionality (including any functionality necessary to support the solutions described above). The various different types of network nodes may include components having the same physical hardware but configured (e.g., via programming) to support different radio access technologies, or may represent partly or entirely different physical components.

Processors, interfaces, and memory similar to those described with respect to FIGS. 9-10 may be included in other network nodes (such as core network node 440). Other network nodes may optionally include or not include a wireless interface (such as the transceiver described in FIGS. 9-10). Functionalities described may reside within the same radio node or network node or may be distributed across a plurality of radios nodes and network nodes.

FIG. 11 illustrates an example of a second radio node 1100 in accordance with certain embodiments. The second radio node 1100 could be a wireless device 410. The second radio node 1100 may include a receiving module 1110, a selecting module 1120 and a transmitting module 1130.

In certain embodiments, the receiving module 1110 may perform a combination of steps that may include steps such as Step 710 in FIG. 7, and Step (or block) 1310 of FIG. 13.

In certain embodiments, the selecting module 1120 may perform a combination of steps that may include steps such as Step 720 in FIG. 7, and step (or block) 1320 in FIG. 13.

In certain embodiments, the transmitting module 1130 may perform a combination of steps that may include steps such as Step 730 in FIG. 7, and step (or block) 1330 in FIG. 13.

In certain embodiments, the receiving module 1110, the selecting module 1120 and the transmitting module 1130 may be implemented using one or more processors, such as described with respect to FIG. 9. The modules may be integrated or separated in any manner suitable for performing the described functionality.

FIG. 12 illustrates an example of the first radio node, such as the radio access node or network node 420 in accordance with certain embodiments. The first radio node may include a determining module 1210, a sending module 1220 and a receiving module 1230.

In certain embodiments, the determining module 1210 may perform a combination of steps that may include steps such as Step 810 in FIG. 8.

In certain embodiments, the sending module 1220 may perform a combination of steps that may include steps such as Step 820 in FIG. 8, and step (or block) 1410 in FIG. 14.

In certain embodiments, the receiving module 1230 may perform a combination of steps that may include steps such as Step 830 in FIG. 8, and step (or block) 1420 in FIG. 14.

In certain embodiments, the determining module 1210, the sending module 1220 and the receiving module 1230 may be implemented using one or more processors, such as described with respect to FIG. 10. The modules may be integrated or separated in any manner suitable for performing the described functionality.

It should be noted that according to some embodiments, virtualized implementations of the wireless device 410 of FIG. 9 and the second radio node of FIG. 11 and the radio access node 420 of FIG. 10, and the first radio node of FIG. 12 are possible. As used herein, a “virtualized” network node (e.g., a virtualized base station or a virtualized radio access node) is an implementation of the network node in which at least a portion of the functionality of the network is implemented as a virtual component (e.g., via a virtual machine(s) executing on a physical processing node(s) in a network(s)). The functions of the wireless device 410 and radio access node 420 (described hereinabove) are implemented at the one or more processing circuitry 910 and 1010 respectively or distributed across a cloud computing system. In some particular embodiments, some or all of the functions of the wireless device 410 and radio access node 420 (described herein) are implemented as virtual components executed by one or more virtual machines implemented in a virtual environment(s) hosted by processing node(s).

Any steps or features described herein are merely illustrative of certain embodiments. It is not required that all embodiments incorporate all the steps or features disclosed nor that the steps be performed in the exact order depicted or described herein. Furthermore, some embodiments may include steps or features not illustrated or described herein, including steps inherent to one or more of the steps disclosed herein.

Any two or more embodiments described in this document may be combined in any way with each other. Furthermore, the described embodiments are not limited to the described radio access technologies (e.g., LTE, NR). That is, the described embodiments can be adapted to other radio access technologies.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order. Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

The above-described embodiments of the present invention are intended to be examples only. Alterations, modifications and variations may be effected to the particular embodiments by those of skill in the art without departing from the scope of the invention, which is defined solely by the claims appended hereto.

Some of the abbreviations used in this disclosure include:
1×RTT CDMA2000 1× Radio Transmission Technology
ABS Almost Blank Subframe
ARQ Automatic Repeat Request
AWGN Additive White Gaussian Noise
BCCH Broadcast Control Channel
BCH Broadcast Channel
CA Carrier Aggregation
CCCH SDU Common Control Channel SDU
CDMA Code Division Multiplexing Access
CGI Cell Global Identifier
CP Cyclic Prefix
CPICH Common Pilot Channel
CPICH Ec/No CPICH Received energy per chip divided by the power density in the band
CQI Channel Quality information
CRC Cyclic Redundancy Check
C-RNTI Cell RNTI
CSI Channel State Information
DCCH Dedicated Control Channel
DL Downlink
DRX Discontinuous Reception
DTX Discontinuous Transmission
DTCH Dedicated Traffic Channel
DUT Device Under Test
E-CID Enhanced Cell-ID (positioning method)
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
GERAN GSM EDGE Radio Access Network
GSM Global System for Mobile communication
gNB Base station in NR
HARQ Hybrid Automatic Repeat Request
HO Handover
HSPA High Speed Packet Access
HRPD High Rate Packet Data
LPP LTE Positioning Protocol
LTE Long Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control CHannel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator CHannel
PDCCH Physical Downlink Control Channel
PDCH Physical Data CHannel
PDSCH Physical Downlink Shared Channel
PGW Packet Gateway
PHICH Physical Hybrid-ARQ Indicator CHannel
PLMN Public Land Mobile Network
PMI Precoder Matrix Indicator
PRACH Physical Random Access CHannel
PRS Positioning Reference Signal
PSS Primary Synchronization Signal
PUCCH Physical Uplink Control CHannel
PUSCH Physical Uplink Shared Channel
RB Resource Block
RLM Radio Link Management
RRC Radio Resource Control
RSCP Received Signal Code Power
RSRP Reference Signal Received Power
RSRQ Reference Signal Received Quality
RSSI Received Signal Strength Indicator
RSTD Reference Signal Time Difference
QAM Quadrature Amplitude Modulation
RACH Random Access Channel
RAR Random Access Response
RAT Radio Access Technology
RNC Radio Network Controller
RNTI Radio Network Temporary Identifier
RRC Radio Resource Control
RRM Radio Resource Management
SCH Synchronization Channel
SCell Secondary Cell
SDU Service Data Unit
SFN System Frame Number
SGW Serving Gateway
SI System Information
SIB System Information Block
SNR Signal Noise Ratio
SON Self Optimized Network
SS Synchronization Signal
SSS Secondary Synchronization Signal
TDD Time Division Duplex
TRP Transmission and Reception Point
TTI Transmission Time Interval
UE User Equipment
UL Uplink
UMTS Universal Mobile Telecommunication System
UTRA Universal Terrestrial Radio Access
UTRAN Universal Terrestrial Radio Access Network
WCDMA Wide CDMA
WLAN Wireless Local Area Network
ZC Zadoff-Chu

### EXAMPLE EMBODIMENTS

1. A method in a first radio node, the method comprising:
determining an allocation of a plurality of Physical Random Access Channel (PRACH) resources for PRACH preamble transmission, wherein each PRACH resource comprises a combination of time, frequency and sequence;
sending the determined allocation of the plurality of PRACH resources to a User equipment (UE); and
receiving a PRACH preamble from the UE, the PRACH preamble being transmitted in a PRACH resource selected from the plurality of PRACH resources.
2. The method of example 1, wherein the first radio node is a network node.
3. The method of example 1 or 2, wherein determining the allocation of the plurality of PRACH resources comprises configuring the plurality of PRACH resources using a combination of time, frequency and sequence.
4. The method of any of examples 1 to 3, wherein the configuration of the plurality of PRACH resources is given in a Master Information Block (MIB) in a Physical Broadcast CHAnnel (PBCH).
5. The method of example 4, wherein the MIB comprises a first indicator for the time, a second indicator for the frequency and a third indicator for the sequence, the first, second and third indicators being separate indicators.
6. The method of example 5, wherein the first indicator indicates a timing offset, the second indicator indicates a frequency resource and the third indicator indicates a preamble root subset.
7. The method of any of examples 4 to 6, wherein several synchronization signals and PBCH transmissions are transmitted in different beams from the first radio node.
8. The method of example 4, wherein the MIB comprises a PRACH preamble index for indicating the combination of time, frequency and sequence.
9. The method of example 8, wherein the sequence comprises a root sequence between 1 to 70 for a Zadoff-Chu sequence with 71 sub-carriers.
10. The method of example 9, wherein the sequence further comprises cyclic shifts of the root sequence.
11. The method of example 8, wherein the frequency comprises a subband index describing a location of a PRACH signal.
12. The method of example 8, wherein the time comprises timing offsets indicating future subframe for a PRACH preamble.
13. The method of example 8, wherein the PRACH preamble index is mapped to a table containing one configuration of sequence, frequency resource and time resource for each index.
14. The method of example 4, further comprising listing sets of allowed combinations of time, frequency and sequence in the MIB.
15. A first radio node comprising circuitry, the first radio node operable to perform any one or more of the methods of examples 1-14.
16. The first radio node of example 15, the circuitry comprising memory and one or more processors.
17. A computer program product comprising a non-transitory computer readable storage medium having computer readable program code embodied in the medium, the computer readable program code comprising computer readable code to perform any one or more of the methods of examples 1-14.
18. A method in a second radio node, the method comprising:
receiving a message from a network node, the message comprising an allocation of a plurality of Physical Random Access Channel (PRACH) resources for PRACH preamble transmission, wherein each PRACH resource comprises a combination of time, frequency and sequence;
selecting a PRACH resource among the plurality of PRACH resources; and
transmitting a PRACH preamble to the network node using the selected PRACH resource.
19. The method of example 18, wherein selecting a PRACH resource comprises selecting randomly a PRACH resource among the plurality of PRACH resources.
20. The method of example 18, wherein selecting a PRACH resource comprises selecting a PRACH resource based on a specific criterion.
21. The method of any of examples 18 to 20, wherein the second radio node is a wireless device.
22. A second radio node comprising circuitry, the second radio node operable to perform any one or more of the methods of examples 18-21.
23. The second radio node of example 22, the circuitry comprising memory and one or more processors.
24. A computer program product comprising a non-transitory computer readable storage medium having computer readable program code embodied in the medium, the computer readable program code comprising computer readable code to perform any one or more of the methods of examples 18-21.
25. A node including circuitry containing instructions which, when executed, cause the first or second radio node to perform any of the methods of the example embodiments described above.
26. A non-transitory computer readable memory configured to store executable instructions for a node, the executable instructions when executed by one or more processors cause the first or second radio node to perform any of the method of the example embodiments described above.

1. A method in a network node for performing an access procedure, the method comprising:
sending a plurality of synchronization signal blocks (SSBs) for indicating allocations of Physical Random Access Channel (PRACH) resources to a wireless device, wherein each of the SSBs indicates a plurality of PRACH resources in one or more time resources and in one or more frequency resources; and
receiving a PRACH preamble from the wireless device during a time resource and a frequency resource selected from one of the plurality of PRACH resources of the plurality of SSBs.

2. The method of claim 1, wherein the one or more time resources comprises one of a time interval and a plurality of timing offsets from a synchronization signal.

3. (canceled)

4. (canceled)

5. (canceled)

6. The method of claim 1, wherein the one or more frequency resources comprise one of a frequency a frequency interval and one or more frequency subbands for indicating a location of a PRACH signal.

7. (canceled)

8. (canceled)

9. (canceled)

10. The method of claim 1, wherein the plurality of PRACH resources further comprises one or more sequences, the one or more sequences comprising a combination of a set of root sequences and a set of cyclic shifts.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A network node for performing an access procedure, the network node comprising processing circuitry and a memory connected thereto, wherein the memory comprises instructions that, when executed, cause the processing circuitry to:
send a plurality of synchronization signal blocks (SSBs) for indicating allocations of Physical Random Access Channel (PRACH) resources to a wireless device, wherein each of the SSBs indicates a plurality of PRACH resources in one or more time resources and in or more frequency resources; and
receive a PRACH preamble from the wireless device during a time resource and a frequency resource selected from one of the plurality of the PRACH resources of the plurality of SSBs.

26. The network node of claim 25, wherein the one or more time resources comprises one of a time interval and a plurality of timing offsets from a synchronization signal.

27. (canceled)

28. (canceled)

29. (canceled)

30. The network node of claim 25, wherein the one or more frequency resources comprise one of a frequency, a frequency interval and one or more frequency subbands for indicating a location of a PRACH signal.

31. (canceled)

32. (canceled)

33. (canceled)

34. The network node of claim 25, wherein the plurality of PRACH resources further comprises one or more sequences, the one or more sequences comprising a combination of a set of root sequences and a set of cyclic shifts.

35. The network node of claim 25, wherein the plurality of SSBs is associated with a plurality of Physical Broadcast Channels (PBCHs).

36. (canceled)

37. (canceled)

38. (canceled)

39. (canceled)

40. (canceled)

41. (canceled)

42. (canceled)

43. (canceled)

44. (canceled)

45. (canceled)

46. A method in a wireless device for performing an access procedure, the method comprising:
receiving, from a network node, a plurality of synchronization signal blocks (SSBs) indicating allocations of Physical Random Access Channel (PRACH) resources, wherein each of the SSBs indicates a plurality of PRACH resources in one or more time resources and in one or more frequency resources;
selecting a PRACH resource from the plurality of PRACH resources of the plurality of SSBs; and
transmitting a PRACH preamble using the selected PRACH resource, to the network node.

47. The method of claim 46, wherein selecting the PRACH resource comprises one of selecting randomly a PRACH resource among the plurality of PRACH resources and selecting a PRACH resource based on a specific criterion.

48. (canceled)

49. The method of claim 46, wherein the one or more time resources comprises one of a time interval and a plurality of timing offsets from a synchronization signal.

50. (canceled)

51. (canceled)

52. (canceled)

53. The method of claim 46, wherein the one or more frequency resources comprise one of a frequency, a frequency interval and one or more frequency subbands for indicating a location of a PRACH signal.

54. (canceled)

55. (canceled)

56. (canceled)

57. The method of claim 46, wherein the plurality of PRACH resources comprises one or more sequences, the one or more sequences comprising a combination of a set of root sequences and a set of cyclic shifts.

58. The method of claim 46, wherein the plurality of SBBs is associated with a plurality of a Physical Broadcast CHAnnels (PBCHs).

59. (canceled)

60. (canceled)

61. (canceled)

62. (canceled)

63. The method of claim 46, wherein the allocations of PRACH resources are indicated by a PRACH preamble index, which is mapped to an index of a table, the table having a list of indexes, each index corresponding to one configuration of one or more time resources, one or more frequency resources and a plurality of sequences.

64. (canceled)

65. (canceled)

66. (canceled)

67. (canceled)

68. (canceled)

69. The method of claim 46, further comprising generating a PRACH preamble based on the selected sequence.

70. A wireless device for performing an access procedure, the wireless device comprising processing circuitry and a memory connected thereto, wherein the memory comprises instructions that, when executed, cause the processing circuitry to:
receive, from a network node, a plurality of synchronization signal blocks (SSBs) indicating allocations of Physical Random Access Channel (PRACH) resources, wherein each of the SSBs indicates a plurality of PRACH resources in one or more time resources and in one or more frequency resources;
select a PRACH resource from the plurality of PRACH resources of the plurality of SSBs; and
transmit a PRACH preamble using the selected PRACH resource, to the network node.

71. The wireless device of claim 70, wherein the processing circuitry is configured to perform one of randomly selecting a PRACH resource among the plurality of PRACH resources and selecting a PRACH resource based on a specific criterion.

72. (canceled)

73. The wireless device of claim 70, wherein the one or more time resources from the first combination comprises one of a time interval and a plurality of timing offsets from a synchronization signal.

74. (canceled)

75. (canceled)

76. (canceled)

77. The wireless device of claim 70, wherein the one or more frequency resources comprise one of a frequency, a frequency interval and one or more frequency subbands for indicating a location of a PRACH signal.

78. (canceled)

79. (canceled)

80. (canceled)

81. The wireless device of claim 70, wherein the plurality of PRACH resources comprises one or more sequences, the one or more sequences comprising a combination of a set of root sequences and a set of cyclic shifts.

82. The wireless device of claim 70, wherein the plurality of SSBs is associated with a plurality of Physical Broadcast Channels (PBCHs).

83. (canceled)

84. The wireless device of claim 70, wherein the processing circuitry is configured to receive the plurality of SSBs in different beams.

85. (canceled)

86. (canceled)

87. The wireless device of claim 70, wherein the allocations of PRACH resources are indicated by a PRACH preamble index, which is mapped to an index of a table, the table having a list of indexes, each index corresponding to one configuration of a plurality of time resources, one or more frequency resources and a plurality of sequences.

88. (canceled)

89. (canceled)

90. (canceled)

91. (canceled)

92. (canceled)

93. The wireless device of claim 70, wherein the processing circuitry is configured to generate a PRACH preamble based on the selected sequence.
